(19) United States
(12) Patent Application Publication
(10) Pub. No.: US 2025/0223763 A1
(43) Pub. Date: Jul. 10, 2025

(54) COMPOSITIONS AND METHODS FOR IMPROVING A PAPERMAKING PROCESS

(71) Applicant: ECOLAB USA Inc., St. Paul, MN (US)

(72) Inventors: Jinming ZHANG, Shanghai (CN); Qinglong RAO, Shanghai (CN)

(73) Assignee: ECOLAB USA Inc., St. Paul, MN (US)

(21) Appl. No.: 18/853,650

(22) PCT Filed: Apr. 13, 2023
(86) PCT No.: PCT/US2023/065743

§ 371 Date: Oct. 2, 2024

(30) Foreign Application Priority Data
Apr. 29, 2022 (CN) 202210473158.5

(51) Int. Cl. D21H 21/18; D21H 17/38; D21H 17/45

(52) U.S. Cl. CPC D21H 21/18; D21H 17/38; D21H 17/45

(57) ABSTRACT

The present disclosure provides compositions and methods for increasing the strength of paper. Some of the methods include reacting a cationic dialdehyde-modified polyacrylamide polymer with an amphoteric polymer to form a mixture, monitoring a pH of the mixture, optionally adjusting the pH of the mixture to a value from about 7.5 to about 14, holding the mixture at the value for a period of time to form a crosslinked polymer, and adding the crosslinked polymer to a pulp furnish.

### TECHNICAL FIELD

The present disclosure relates to the field of papermaking. More specifically, the disclosure relates to compositions and methods for increasing strength and ash retention of paper.

### BACKGROUND

Chemical additives for papermaking play an important role in the sustainable development of the papermaking industry. Such additives include processing aids and functional aids, such as strength aids. The strength parameters of paper include, for example, dry strength, wet strength, and temporary wet strength.

Frequently used dry strength aids include, for example, natural polymers (e.g., cationic starch, carboxymethylcellulose, guar gum), and synthetic polymers (e.g., polyacrylamide, glyoxalated polyacrylamide, polyvinylamine). Polyacrylamide dry strength aids are widely used and can be categorized into anionic, cationic and amphoteric types. Amphoteric polyacrylamide polymers have been developed by copolymerization of anionic vinyl monomers and cationic vinyl monomers, in addition to acrylamide monomers. Dialdehyde-functionalized polyacrylamide, which can be prepared from dialdehyde and polyacrylamide, were first developed as temporary wet strength resins and then developed as dry strength resins used in combinations with wet strength resins. Glyoxalated polyacrylamide, which can be prepared from glyoxal and backbone polyacrylamide, is widely used as a dry strength aid. Dialdehyde-functionalized polyacrylamides, such as glyoxalated polyacrylamides, were developed to impart paper with enhanced dry strength, wet strength and/or drainage ability.

Dialdehyde-modified cationic, anionic and amphoteric acrylamide-containing polymers, particularly glyoxalated diallyldimethylammonium chloride/acrylamide copolymers, are used as dry strength and temporary wet strength aids in producing paper and paperboard. These polymer strength aids provide advantageous wet strength and dry strength, and also help improve the paper machine runnability.

### BRIEF SUMMARY

In certain aspects, the present disclosure provides compositions and methods for increasing strength and ash retention of paper. Certain methods disclosed herein comprise reacting a cationic dialdehyde-modified polyacrylamide polymer with an amphoteric polymer to form a mixture; monitoring a pH of the mixture; optionally adjusting a pH of the mixture to a value from about 7.5 to about 14; holding the mixture at the value for a period of time to form a crosslinked polymer; and adding the crosslinked polymer to a pulp furnish.

In some embodiments, the period of time is from about 0.01 minutes to about 360 minutes.

In some embodiments, the crosslinked polymer comprises from about 1 mol % to about 40 mol % of a cationic monomer and from about 1 mol % to about 40 mol % of an anionic monomer. In certain embodiments, the crosslinked polymer comprises a ratio of amphoteric polymer to cationic dialdehyde-modified polyacrylamide polymer of about 1:100 to about 100:1.

In certain embodiments, the cationic dialdehyde-modified polyacrylamide polymer comprises a cationic to anionic charge ratio of greater than 1:1.

In some embodiments, the cationic dialdehyde-modified polyacrylamide polymer comprises a monomer selected from the group consisting of diallyldimethylammonium chloride, N-(3-dimethylaminopropyl)methacrylamide, N-(3-dimethylaminopropyl) acrylamide, trimethyl-2-methacroyloxyethylammonium chloride, trimethyl-2-acroyloxyethyl ammonium chloride, methylacryloxyethyldimethyl benzyl ammounium chloride, acryloxyethyldimethyl benzyl ammounium chloride, (3-acrylamidopropyl)trimethyl ammonium chloride, (3-methacrylamidopropyl)trimethylammonium chloride, (3-acrylamido-3-methylbutyl)trimethylammonium chloride, 2-vinylpyridine, 2-(dimethylamino)ethyl methacrylate, 2-(dimethylamino)ethyl acrylate, a salt of any of the foregoing monomers, and any combination thereof.

In some embodiments, the amphoteric polymer comprises a monomer selected from the group consisting of acrylamide, methacrylamide, diallyldimethylammonium chloride, N-(3-dimethylaminopropyl)methacrylamide, N-(3-dimethylaminopropyl) acrylamide, trimethyl-2-methacroyloxyethylammonium chloride, trimethyl-2-acroyloxyethyl ammonium chloride, methylacryloxyethyldimethyl benzyl ammounium chloride, acryloxyethyldimethyl benzyl ammounium chloride, (3-acrylamidopropyl)trimethyl ammonium chloride, (3-methacrylamidopropyl)trimethylammonium chloride, (3-acrylamido-3-methylbutyl)trimethylammonium chloride, 2-vinylpyridine, 2-(dimethylamino)ethyl methacrylate, 2-(dimethylamino)ethyl acrylate, acrylic acid, methacrylic acid, itaconic acid, maleic acid, maleic anhydride, a salt of any of the foregoing monomers, and any combination thereof.

In certain embodiments, the amphoteric polymer comprises an anionic to cationic charge ratio of about 10:1 to about 1:10. In certain embodiments, the amphoteric polymer comprises an anionic to cationic charge ratio of about 5:1 to about 0.5:1.

In some embodiments, the pH value is between about 9.0 and about 10.

In some embodiments, the crosslinked polymer comprises a weight average molecular weight from about 500,000 Da to about 10,000,000 Da.

In certain embodiments, a dry strength agent is added to the mixture. In certain embodiments, an effective amount of a base is added to the mixture.

In some embodiments, the methods further comprise monitoring a turbidity of the mixture and adding the crosslinked polymer to the pulp furnish when a turbidity value reaches about 20 to about 500 NTU. In some embodiments, the methods further comprise obtaining a first turbidity value of the mixture before the holding step, monitoring a turbidity of the mixture during the holding step, and adding the crosslinked polymer to the pulp furnish when the turbidity of the mixture increases by at least about 5% as compared to the first turbidity value.

In some embodiments, the cationic dialdehyde-modified polyacrylamide polymer is a cationic glyoxalated polyacrylamide polymer.

In certain embodiments, the holding step is performed in the absence of fiber.

The present disclosure also provides a method of increasing the strength of paper comprising reacting a cationic dialdehyde-modified polyacrylamide polymer with an amphoteric polymer to form a mixture comprising a crosslinked polymer; obtaining a first turbidity value of the mixture; holding the mixture for a period of time; monitoring a turbidity of the mixture during the holding step; and adding the crosslinked polymer to a pulp furnish when the turbidity of the mixture increases by about 5% as compared to the first turbidity value.

In some embodiments, the period of time is from about 0.01 minutes to about 360 minutes.

In some embodiments, the amphoteric polymer comprises a net anionic charge when a pH of the mixture is above 5.0.

In certain embodiments, the crosslinked polymer comprises from about 1 mol % to about 40 mol % of a cationic monomer and from about 1 mol % to about 40 mol % of an anionic monomer.

In some embodiments, the cationic dialdehyde-modified polyacrylamide polymer comprises a monomer selected from the group consisting of diallyldimethylammonium chloride, N-(3-dimethylaminopropyl)methacrylamide, N-(3-dimethylaminopropyl) acrylamide, trimethyl-2-methacroyloxyethylammonium chloride, trimethyl-2-acroyloxyethyl ammonium chloride, methylacryloxyethyldimethyl benzyl ammounium chloride, acryloxyethyldimethyl benzyl ammounium chloride, (3-acrylamidopropyl)trimethyl ammonium chloride, (3-methacrylamidopropyl)trimethylammonium chloride, (3-acrylamido-3-methylbutyl)trimethylammonium chloride, 2-vinylpyridine, 2-(dimethylamino)ethyl methacrylate, 2-(dimethylamino)ethyl acrylate, a salt of any of the foregoing monomers, and any combination thereof.

In some embodiments, the amphoteric polymer comprises a monomer selected from the group consisting of acrylamide, methacrylamide, diallyldimethylammonium chloride, N-(3-dimethylaminopropyl)methacrylamide, N-(3-dimethylaminopropyl) acrylamide, trimethyl-2-methacroyloxyethylammonium chloride, trimethyl-2-acroyloxyethyl ammonium chloride, methylacryloxyethyldimethyl benzyl ammounium chloride, acryloxyethyldimethyl benzyl ammounium chloride, (3-acrylamidopropyl)trimethyl ammonium chloride, (3-methacrylamidopropyl)trimethylammonium chloride, (3-acrylamido-3-methylbutyl)trimethylammonium chloride, 2-vinylpyridine, 2-(dimethylamino)ethyl methacrylate, 2-(dimethylamino)ethyl acrylate, acrylic acid, methacrylic acid, itaconic acid, maleic acid, maleic anhydride, a salt of any of the foregoing monomers, and any combination thereof.

In certain embodiments, the amphoteric polymer comprises an anionic to cationic charge ratio of about 10:1 to about 1:10. In certain embodiments, the amphoteric polymer comprises an anionic to cationic charge ratio of about 5:1 to about 0.5:1.

In some embodiments, the mixture comprises a pH value from about 9 to about 10.

In some embodiments, the crosslinked polymer comprises a weight average molecular weight from about 1,000,000 Da to about 10,000,000 Da.

In certain embodiments, a dry strength agent is added to the mixture.

In some embodiments, an effective amount of a base is added to the mixture. In certain embodiments, the base is selected from the group consisting of sodium hydroxide, potassium hydroxide, ammonia, and any combination thereof.

Additionally, the present disclosure provides a method of increasing the strength of paper, comprising reacting a cationic dialdehyde-modified polyacrylamide polymer with an amphoteric polymer to form a mixture; monitoring a pH of the mixture; holding the pH of the mixture to a value from about 7.5 to about 14 for a period of time to form a crosslinked polymer; and adding the crosslinked polymer to a pulp furnish.

In some embodiments, the pH of the mixture is adjusted to a value between about 7.5 and about 14.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE SEVERAL VIEWS OF THE DRAWINGS

A detailed description of the invention is hereafter described with specific reference being made to the drawings in which:

FIG. 1 contains a graph showing how pH affects the mixtures disclosed herein;

FIG. 2 contains a bar graph showing strength of paper prepared with mixtures having different pH values; and

FIGS. 3 and 4 contain graph showing the effects of holding the mixture of cationic dialdehyde-modified polyacrylamide polymer and amphoteric polymer for a period of time to promote extensive crosslinking.

### DETAILED DESCRIPTION

Unless otherwise defined, all technical and scientific terms used herein have the same meaning as commonly understood by one of ordinary skill in the art. In case of conflict, the present document, including definitions, will control. Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The term “pulp slurry” means a mixture comprising a liquid medium, such as water, within which solids, such as fibers (for example cellulose fibers) and optionally fillers, are dispersed or suspended such that between about >99% to about 45% by mass of the slurry is liquid medium. The portion of the papermaking process prior to the press section where a liquid medium, such as water, comprises more than about 45% of the mass of the substrate is referred to as the “wet end.” Conversely, the term “dry end” refers to that portion of the papermaking process including and subsequent to the press section where a liquid medium, such as water, typically comprises less than about 45% of the mass of the substrate. The compositions and methods disclosed herein can be incorporated into or carried out in the “wet end” and/or “dry end” of the papermaking process.

The term “sizing agent” refers to any additive that provides water-holdout to a composition of the present disclosure. Conventional papermaking sizing agents include rosin-based products, alkenyl succinic anhydrides, alkyl ketene dimers, styrene-maleic anhydride copolymers, styrene-acrylate and methacrylate copolymers, polyurethanes, wax emulsions, wax dispersions or a mixture thereof. The selection and amount of sizing agent can depend on the specific end-use requirements of the paper and/or paperboard products and is within the purview of a person of ordinary skill in the art of papermaking.

The term “size press” means the part of the papermaking process where the dry paper is rewet by applying a liquid mixture that comprises starch and other additives, such as sizing agents and optical brightening agents. A more detailed description of a size press is described in the reference Handbook for Pulp and Paper Technologists, 3rd Edition, by Gary A. Smook, Angus Wilde Publications Inc., (2002), the contents of which are incorporated by reference into the present application. The size press can be a conventional metered size press or non-metered size press. Any size press design can be used, including, but not limited to, horizontal press, vertical press, gate roll size press and metering blade size press, rod, puddle type, or combinations thereof.

The paper manufacturing process can be organized into different general sections. For example, one section includes the location where a pulp slurry is disposed as thin layer on a moving papermaking wire or forming fabric. Another section is commonly referred to as the “press section,” which is where the thin layer is pressed to remove additional water. Following that is the dryer section where the pressed layer moves through a series of heated rollers. At this point, the dry substrate can be rewetted by passing it through a size press and further dried by passing it through another set of heated rollers. Finally, the dried substrate passes through a paper finishing section, such as a calendaring section (see, for example, Handbook for Pulp and Paper Technologists, 3rd Edition, by Gary A. Smook, Angus Wilde Publications Inc., (2002) and The Nalco Water Handbook (3rd Edition), by Daniel Flynn, McGraw Hill (2009)). The compositions and methods disclosed herein can be incorporated into or carried out in any of the foregoing sections.

In some embodiments, the compositions of the present disclosure comprise a crosslinked polymer. The crosslinked polymer may be formed by reacting a cationic dialdehyde-modified polyacrylamide polymer with an amphoteric polymer to form a mixture. In certain embodiments, the mixture has a pH of about 7 to about 14, such as from about 8 to about 14, about 9 to about 14, about 9 to about 13, about 9 to about 12, about 9 to about 11, or about 9 to about 10.

Any dialdehyde may be reacted with the polyacrylamide polymer such as, but not limited to, glyoxal, malonaldehyde, succinic aldehyde and glutaraldehyde. For example, the dialdehyde may be glyoxal.

In some embodiments, the cationic dialdehyde-modified polyacrylamide polymer comprises a cationic monomer selected from the group consisting of diallyldimethylammonium chloride, N-(3-dimethylaminopropyl)methacrylamide, N-(3-dimethylaminopropyl)acrylamide, trimethyl-2-methacroyloxyethylammonium chloride, trimethyl-2-acroyloxyethylammonium chloride, methylacryloxyethyldimethyl benzyl ammounium chloride, acryloxyethyldimethyl benzyl ammounium chloride, (3-acrylamidopropyl)trimethylammonium chloride, (3-methacrylamidopropyl)trimethylammonium chloride, (3-acrylamido-3-methylbutyl)trimethylammonium chloride, 2-vinylpyridine, 2-(dimethylamino)ethyl methacrylate, 2-(dimethylamino)ethyl acrylate, a salt of any of the foregoing monomers, and any combination thereof. For example, the cationic dialdehyde-modified polyacrylamide polymer may comprise diallyldimethylammonium chloride.

In some embodiments, the cationic dialdehyde-modified polyacrylamide polymer comprises an anionic monomer selected from the group consisting of acrylic acid, methacrylic acid, itaconic acid, maleic acid, maleic anhydride, a salt of any of the foregoing monomers, and any combination thereof. For example, the cationic dialdehyde-modified polyacrylamide polymer may comprise acrylic acid.

In some embodiments, the cationic dialdehyde-modified polyacrylamide polymer comprises a non-ionic monomer selected from the group consisting of acrylamide, methacrylamide, N,N-dimethylacrylamide, N,N-diethylacrylamide, N-isopropylacrylamide, N-vinylformamide, N-vinylmethylacetamide, N-vinyl pyrrolidone, hydroxyethyl methacrylate, hydroxyethyl acrylate, hydroxypropyl acrylate, hydroxypropyl methacrylate, N-tert-butylacrylamide, N-methylolacrylamide, diallylamine, allylamine, and any combination thereof.

In some embodiments, the cationic dialdehyde-modified polyacrylamide polymer comprises a net cationic charge. In some embodiments, the cationic dialdehyde-modified polyacrylamide polymer comprises a cationic, anionic, and/or non-ionic monomer. In certain embodiments, the cationic dialdehyde-modified polyacrylamide polymer excludes an anionic monomer.

The cationic dialdehyde-modified polyacrylamide polymer may comprise an appropriate molar percentage of each monomer. For example, the polymer may comprise from about 1 mol. % to about 95 mol. % of the cationic monomer, such as from about 1 mol. % to about 90 mol. %, about 1 mol. % to about 80 mol. %, about 1 mol. % to about 70 mol. %, about 1 mol. % to about 60 mol. %, about 1 mol. % to about 50 mol. %, about 1 mol. % to about 40 mol. %, about 1 mol. % to about 30 mol. %, about 1 mol. % to about 20 mol. %, about 1 mol. % to about 10 mol. %, about 1 mol. % to about 5 mol. %, about 10 mol. % to about 95 mol. %, about 20 mol. % to about 95 mol. %, about 30 mol. % to about 95 mol. %, about 40 mol. % to about 95 mol. %, about 50 mol. % to about 95 mol. %, about 60 mol. % to about 95 mol. %, about 70 mol. % to about 95 mol. %, about 80 mol. % to about 95 mol. %, or about 90 mol. % to about 95 mol. % of the cationic monomer.

In some embodiments, the cationic dialdehyde-modified polyacrylamide polymer comprises from about 0 mol. % to about 45 mol. % of the anionic monomer. For example, the polymer may comprise from about 1 mol. % to about 40 mol. %, about 1 mol. % to about 35 mol. %, about 1 mol. % to about 30 mol. %, about 1 mol. % to about 25 mol. %, about 1 mol. % to about 20 mol. %, about 1 mol. % to about 15 mol. %, about 1 mol. % to about 10 mol. %, or about 1 mol. % to about 5 mol. % of the anionic monomer.

In some embodiments, the cationic dialdehyde-modified polyacrylamide polymer comprises from about 1 mol. % to about 99 mol. % of the non-ionic monomer. For example, the polymer may comprise from about 1 mol. % to about 90 mol. %, about 1 mol. % to about 80 mol. %, about 1 mol. % to about 70 mol. %, about 1 mol. % to about 60 mol. %, about 1 mol. % to about 50 mol. %, about 1 mol. % to about 40 mol. %, about 1 mol. % to about 30 mol. %, about 1 mol. % to about 20 mol. %, about 1 mol. % to about 10 mol. %, about 1 mol. % to about 5 mol. %, about 10 mol. % to about 95 mol. %, about 20 mol. % to about 95 mol. %, about 30 mol. % to about 95 mol. %, about 40 mol. % to about 95 mol. %, about 50 mol. % to about 95 mol. %, about 60 mol. % to about 95 mol. %, about 70 mol. % to about 95 mol. %, about 80 mol. % to about 95 mol. %, or about 90 mol. % to about 95 mol. % of the non-ionic monomer.

In some embodiments, the cationic dialdehyde-modified polyacrylamide polymer comprises a cationic to anionic charge ratio of greater than 1:1, such as about 2:1, about 3:1, about 4:1, about 5:1, about 10:1, about 15:1, about 20:1, about 30:1, about 40:1, about 50:1, about 60:1, about 70:1, about 80:1, about 90:1, or about 100:1.

In some embodiments, the ratio of aldehyde to acrylamide in the cationic dialdehyded-modified polyacrylamide polymer is from about 0.01:1 to about 1:1, such as about 0.1:1 to about 0.8:1, about 0.1:1 to about 0.7:1, about 0.1:1 to about 0.6:1, about 0.1:1 to about 0.5:1, about 0.1:1 to about 0.4:1, or about 0.1:1 to about 0.2:1. For example, if the dialdehyde is glyoxal, the glyoxal/acrylamide ratio (G/A ratio) in the cationic dialdehyde-modified polyacrylamide polymer may be about 0.01:1 to about 1:1.

The weight average molecular weight of the cationic dialdehyde-modified polyacrylamide polymer is not particularly limited. For example, the polymer may have a molecular weight of about 100,000 Da to about 10,000,000 Da, such as from about 200,000 Da to about 5,000,000 Da, about 300,000 Da to about 3,000,000 Da, about 500,000 Da to about 2,500,000 Da, about 750,000 Da to about 2,000,000 Da, or about 1,000,000 Da to about 1,500,000 Da.

In some embodiments, the molecular weight may be about 500,000 Da to about 2,000,000 Da, about 800,000 Da to about 1,500,000 Da, or about 1,000,000 Da to about 1,200,000 Da.

The cationic dialdehyde-modified polyacrylamide polymer of the present disclosure may comprise any combination of the monomers contemplated by the present disclosure. For example, the cationic dialdehyde-modified polyacrylamide polymer may comprise glyoxalated polyacrylamide and diallyldimethylammonium chloride, which may be referred to as a “GPAM/DADMAC” polymer. The GPAM/DADMAC polymer may have, for example, a glyoxal/acrylamide ratio of about 0.01:1 to about 1:1. In some embodiments, the GPAM/DADMAC polymer comprises from about 50 to about 99 mol. % of the acrylamide and from about 1 to about 50 mol. % of the DADMAC.

In certain embodiments, the cationic polyacrylamide polymer, before reaction with dialdehyde, comprises one of the following members of Table 1. The DADMAC mole ratio in Table 1 refers to the mole % of DADMAC to 1 mole % acrylamide. In some embodiments, these members have weight average molecular weights between about 1,000 Da to about 100,000 Da, such as about 1,000 Da to about 75,000 Da, about 1,000 Da to about 50,000 Da, about 5,000 to about 50,000 Da, or about 25,000 Da to about 50,000 Da. The solid percent refers to the amount of polymer in the aqueous solution after synthesis.

TABLE 1

| | | Charge | | |
|---|---|---|---|---|
| | DADMAC | density | | |
| | mole ratio | (meq/g) | IV (dl/g) | Solid % |
| Backbone 1 | +25% | 2.69 | 0.219 | 51.45 |
| Backbone 2 | +20% | 2.44 | 0.289 | 48.06 |
| Backbone 3 | +15% | 2.28 | 0.299 | 54.08 |
| Backbone 4 | +12% | 1.73 | 0.270 | 48.70 |

In some embodiments, when glyoxal is reacted with the polyacrylamide polymer, the resulting cationic GPAM comprises a member of Table 2.

TABLE 2

| GPAM | G/A | Final BFV (cp) |
|---|---|---|
| 25% charge | 0.4 | 25.8 |
| 25% charge | 0.8 | 26.4 |
| 15% charge | 0.4 | 25.7 |
| 15% charge | 0.8 | 54.3 |
| 12% charge | 0.4 | 23.4 |

In some embodiments, when glyoxal is reacted with the polyacrylamide polymer, the resulting cationic GPAM comprises a member of Table 3.

TABLE 3

| | | Backbone | | | |
|---|---|---|---|---|---|
| | | charge | | | |
| GPAM | DADMAC | density | Backbone | | Final |
| samples | ratio | (meq/g) | IV (dl/g) | G/A | BFV (cp) |
| 25% charge | 25% | 2.69 | 0.219 | 0.4 | 25.8 |
| 20% charge | 20% | 2.44 | 0.289 | 0.4 | 26.4 |
| 15% charge | 15% | 2.28 | 0.299 | 0.4 | 25.7 |
| 12% charge | 12% | 1.73 | 0.270 | 0.4 | 54.3 |
| 12% charge | 12% | 1.67 | 0.185 | 0.4 | 20.0 |
| 4% charge | 4% | 0.50 | 0.160 | 0.4 | 35.4 |

An amphoteric polymer is reacted with the cationic dialdehyde-modified polyacrylamide polymer to form the crosslinked polymer in the mixture. In some embodiments, the amphoteric polymer comprises a net anionic charge when a pH of the mixture is above about 5.0.

In certain embodiments, the amphoteric polymer has a weight average molecular weight ranging from about 500,000 Da to about 10,000,000 Da. For example, the weight average molecular weight of the amphoteric polymer may be from about 750,000 Da to about 7,500,000 Da, about 1,000,000 Da to about 3,000,000 Da, about 1,000,000 to about 5,000,000 Da, about 2,500,000 Da to about 6,000,000 Da, or about 2,000,000 Da to about 4,000,000 Da.

The amphoteric polymer may comprise any combination of cationic, anionic, and/or non-ionic monomers. The amphoteric polymer may have an overall negative (anionic) charge or the amphoteric polymer may have an overall positive (cationic) charge. In some embodiments, the amphoteric polymer comprises an anionic to cationic charge ratio of about 10:1 to about 1:10, such as about 8:1, about 6:1, about 4:1, about 2:1, about 1:1, about 1:2, about 1:4, about 1:6, or about 1:8.

In certain embodiments, the amphoteric polymer comprises a monomer selected from the group consisting of diallyldimethylammonium chloride, N-(3-dimethylaminopropyl)methacrylamide, N-(3-dimethylaminopropyl)acrylamide, trimethyl-2-methacroyloxyethylammonium chloride, trimethyl-2-acroyloxyethylammonium chloride, methylacryloxyethyldimethyl benzyl ammounium chloride, acryloxyethyldimethyl benzyl ammounium chloride, (3-acrylamidopropyl)trimethylammonium chloride, (3-methacrylamidopropyl)trimethylammonium chloride, (3-acrylamido-3-methylbutyl)trimethylammonium chloride, 2-vinylpyridine, 2-(dimethylamino)ethyl methacrylate, 2-(dimethylamino)ethyl acrylate, a salt of any of the foregoing monomers, and any combination thereof.

In certain embodiments, the amphoteric polymer comprises a monomer selected from the group consisting of acrylic acid, methacrylic acid, itaconic acid, maleic acid, maleic anhydride, a salt of any of the foregoing monomers, and any combination thereof.

In certain embodiments, the amphoteric polymer comprises a monomer selected from the group consisting of acrylamide, methacrylamide, N,N-dimethylacrylamide, N,N-diethylacrylamide, N-isopropylacrylamide, N-vinylformamide, N-vinylmethylacetamide, N-vinyl pyrrolidone, hydroxyethyl methacrylate, hydroxyethyl acrylate, hydroxypropyl acrylate, hydroxypropyl methacrylate, N-tert-butylacrylamide, N-methylolacrylamide, diallylamine, allylamine, and any combination thereof.

The reaction of the amphoteric polymer with the cationic dialdehyde-modified polyacrylamide polymer can take place in any suitable reaction medium, such as water, toluene, methanol, and/or ethanol, for example.

In some embodiments, an agent, such as a crosslinking agent and/or a chain-transfer agent may be added to the reaction medium before, concurrently with, and/or after the cationic dialdehyde-modified polyacrylamide polymer and/or the amphoteric polymer to provide a branched and/or crosslinked polymeric structure. In some embodiments, the agent is selected from the group consisting of a polyaldehyde, ethylene glycol di(meth)acrylate, diethyieneglycol di(meth)acrylate, methylene-bis-acrylamide, methylene-bis-(meth)acrylamide, ethylene-bis-(meth)acrylamide, hexamethylene-bis-(meth)acrylamide, and any combination thereof.

In some embodiments, the crosslinked polymer may comprise from about 1 mol. % to about 99 mol. % of a cationic monomer, from about 1 mol. % to about 99 mol. % of a non-ionic monomer, and from about 0 mol % to about 95 mol % of an anionic monomer.

In some embodiments, the crosslinked polymer comprises a ratio of amphoteric polymer to cationic dialdehyde-modified polyacrylamide polymer of about 1:100 to about 100:1. For example, the ratio may be about 1:100, about 1:75, about 1:50, about 1:25, about 1:10, about 1:5, about 1:1, about 5:1, about 10:1, about 25:1, about 50:1, or about 75:1.

In some embodiments, the crosslinked polymer comprises a weight average molecular weight from about 1,000,000 Da to about 10,000,000 Da, such as about 1,000,000 Da to about 8,000,000 Da, about 1,000,000 Da to about 6,000,000 Da, about 1,000,000 Da to about 4,000,000 Da, about 1,000,000 Da to about 2,000,000 Da, about 1,500,000 Da to about 3,000,000 Da, or about 2,500,000 Da to about 5,000,000 Da.

The mixture of the present disclosure, which comprises the crosslinked polymer, may comprise additional components such as, but not limited to, a wet strength agent, a dry strength agent, a filler, a retention aid, an optical brightener, a pigment, a sizing agent, starch, a dewatering agent, a microparticle, a coagulant, an enzyme, a biocide, and any combination thereof.

In some embodiments, the dry strength agent is a polyacrylamide-based amphoteric polymer containing from about 3 mol. % to about 10 mol. % of a cationic monomer and from about 0.5 mol. % to about 4 mol. % of an anionic monomer.

In some embodiments, the mixture may comprise a polyvinyl alcohol, a urea-formaldehyde resin, a melamine formaldehyde resin, a polyethyleneimine, a polyethylene oxide, a polyamide-epichlorohydrin resin, and any combination thereof.

In some embodiments, the methods disclosed herein comprise reacting a cationic dialdehyde-modified polyacrylamide polymer as defined herein with an amphoteric polymer as defined herein to form a mixture. A pH of the mixture is monitored, either manually and/or automatically, by any method known in the art, such as through the use of a pH probe or sensor. If the pH of the mixture needs to be increased, the pH of the mixture may be adjusted by addition of an effective amount of a base, such as sodium hydroxide, ammonia and/or potassium hydroxide. If the pH of the mixture needs to be lowered, the pH may be adjusted by addition of an effective amount of an acid, such as hydrochloric acid or acetic acid.

In some embodiments, the pH is adjusted to a value from about 7 to about 14, such as to a value from about 7.5 to about 12, to a value from about 8 to about 12, to a value from about 8 to about 11, to a value from about 8 to about 10, to a value from about 9 to about 10, to a value from about 9 to about 11, to a value from about 9 to about 12, to a value from about 9 to about 13, or to a value from about 9 to about 14. In certain embodiments, the pH of the mixture is held between a value from about 7 to about 14, such as to a value from about 7.5 to about 12, to a value from about 8 to about 12, to a value from about 8 to about 11, to a value from about 8 to about 10, to a value from about 9 to about 10, to a value from about 9 to about 11, to a value from about 9 to about 12, to a value from about 9 to about 13, or to a value from about 9 to about 14. In certain embodiments, the pH of the mixture is between about 9.0 and about 9.7, such as from about 9.3 to about 9.7.

The mixture may be held or stored in the reaction vessel, a mixing tank, a holding tank, a pipeline, etc., for a period of time sufficient to form a crosslinked polymer. In some embodiments, the mixture may be held or stored in the absence of cellulose fibers, for a period of time sufficient to form a crosslinked polymer. In some embodiments, the mixture may be mixed or stirred during the holding period of time.

The holding period of time is variable and depends on a variety of factors, such as temperature, pH, selected monomers, etc. In some embodiments, the holding period is from about 0.01 minutes to about 360 minutes. For example, the holding period may be from about 0.1 minutes to about 300 minutes, from about 1 minute to about 250 minutes, from about 1 minute to about 200 minutes, from about 1 minute to about 150 minutes, from about 1 minute to about 100 minutes, from about 1 minute to about 50 minutes, from about 3 minutes to about 120 minutes, from about 3 minutes to about 180 minutes, from about 3 minutes to about 240 minutes, or from about 3 minutes to about 300 minutes.

At the conclusion of the holding period, the crosslinked polymer may be added to a pulp furnish and/or stored for future use in a papermaking process. The mixture comprising the crosslinked polymer may be in the form of a solution or dispersion, for example, when added to the pulp furnish.

Once added to the pulp furnish, the furnish may be disposed as a thin layer on a moving papermaking wire or forming fabric and subsequently pressed to remove water. At that point, the pressed layer may be transported through a series of heated rollers, optionally, passed through a size press, and optionally dried once again by passing it through another set of heated rollers. Finally, the dried substrate may pass through a paper finishing section, such as a calendaring section.

By including the presently disclosed composition in the aforementioned papermaking process, the resulting paper product has improved strength and the ash retention in the paper product can be substantially increased as compared to a paper product manufactured without the composition of the present disclosure.

Certain methods disclosed herein include a step of monitoring the turbidity of the mixture and adding the crosslinked polymer to the pulp furnish when a particular turbidity value is reached. For example, in some embodiments, the initial turbidity measured after combining the cationic dialdehyde-modified polyacrylamide polymer and the amphoteric polymer may be from about 10 NTU to about 150 NTU. The turbidity is measured during the holding period of time and when it reaches about 20 NTU to about 300 NTU, an appropriate level of crosslinking has occurred and the crosslinked polymer is ready to be added to the pulp furnish.

In some embodiments, a first turbidity value of the mixture is measured/obtained before the holding step (e.g., immediately after the amphoteric polymer and cationic dialdehyde-modified polyacrylamide polymer are initially combined and/or before the pH is adjusted to above about 7, such as to about 8, to about 9, or to about 10). Thereafter, such as during the holding step, which may include mixing, turbidity values of the mixture can be measured/obtained constantly or intermittently. Once a turbidity value is obtained that is a certain percentage higher than the first turbidity value, the crosslinked polymer is ready to be added to the pulp furnish.

For example, the crosslinked polymer may be ready to be added to the pulp furnish or stored when a turbidity value increases by at least about 5%, for example, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 100%, or greater than about 100%, as compared to the first turbidity value obtained immediately after the amphoteric polymer and cationic dialdehyde-modified polyacrylamide polymer are combined.

In some embodiments, the present disclosure provides a method of increasing the strength of paper, which includes reacting a cationic dialdehyde-modified polyacrylamide polymer as defined herein with an amphoteric polymer as defined herein to form a mixture. A first turbidity value of the mixture is obtained either before or after a pH of the mixture is raised to above about 7 (such as from about 9 to about 10), which is followed by a holding period (with optional mixing) where crosslinking or additional crosslinking occurs. The turbidity of the mixture is monitored during the holding step and the crosslinked polymer is added to a pulp furnish when the turbidity of the mixture increases by about 10% as compared to the first turbidity value.

In certain embodiments, about 190 g DI water, about 5 g amphoteric polymer (containing about 92% acrylamide, about 5% 2-(dimethylamino)ethyl methacrylate (DMAEM), about 0.5% dimethylaminoethyl acrylate methyl chloride quaternary salt (DMAEA.MCQ) and about 2% itaconic acid, which has a weight average molecular weight between about 1,200,000 Da and about 2,000,000 Da), and about 5 g cationic GPAM are added to a reaction vessel. A first turbidity measurement is then taken. The mixture may then be stirred for about 10 minutes and the pH of the mixture may be slowly adjusted to a pH between about 9.0 and about 9.7 by adding 10% NaOH. Meanwhile, turbidity of the mixture may be recorded periodically, such as every 60 seconds. Once the target pH is reached, the solution may be held for an additional 3 hours, with optional stirring. Turbidity can be periodically recorded, such as every 1, 5, 10, 15, 20, 25, or 30 minutes, during the holding period. Once the desired increase on turbidity is obtained, the mixture, or any portion thereof, may be added to the pulp furnish.

The dosage of the crosslinked polymer added to the pulp furnish can be determined by one of ordinary skill in the art according to the practical requirements. For example, the dosage may be about 0.01 kg/ton dry fiber to about 50 kg/ton dry fiber, such as from about 0.1 to about 40, about 0.1 to about 30, about 0.1 to about 20, or about 0.1 to about 10 kg/ton dry fiber.

The compositions and methods disclosed herein lead to numerous beneficial technical effects, such as increasing the ash retention of the finished paper and/or increasing the strength of finished paper.

The raw fiber material for papermaking or the paper pulp component itself can contain an amount of mineral matter. During the papermaking process, a certain amount of mineral matter can be added in order to save the cost of the raw fiber material. After the paper is burned and calcinated, the remaining mineral matter is referred to as “ash.” After the paper, paperboard and/or pulp is burned at a specified temperature, “ash retention” refers to the ratio by mass of the remaining matter to the original oven-dry specimen.

The ash retention can be calculated by the following formula: Ash Retention %=(m2−m1)/(m)100%, wherein m1 is the mass of the crucible after burning (grams), m2 is the mass of the crucible containing ash after burning (grams), and m is the oven-dried mass of the specimen (grams).

Ash content of paper and paperboard can be measured according to, for example, ASTM D586, the steps of which are expressly incorporated into the present disclosure.

In some embodiments, the cationic dialdehyde-modified polyacrylamide polymer and the amphoteric polymer are mixed together at an elevated pH, such as greater than about 9 or from about 9 to about 10, to promote crosslinking. The inventors unexpectedly discovered that such crosslinking provides a dry strength boost and maintains superior dewatering performance. Extending the mixing/holding time could further improve the paper strength due to additional crosslinks having time to form.

The foregoing may be better understood by reference to the following examples, which are intended for illustrative purposes and are not intended to limit the scope of the disclosure or its application in any way.

### Examples

Paper sheets were evaluated for basis weight, Scott bond and burst. Scott bond was measured according to T541 om-89, the steps of which are expressly incorporated by reference into the present disclosure. Briefly, the energy required to separate the paper sheet by mechanical equipment is measured to reflect to the magnitude of the internal bonding strength. The measurement of the internal bonding strength expresses the resistant force that is required to overcome to separate the single or multiple fiber layer(s). The test method includes the determination of the force applied by a pendulum to splitting the paper along Z-direction. When the fibers of a hand sheet align in X-Y plane, the exhausted energy is mainly used for the bonding of the fiber. The length of the fiber and the strength of the fiber itself have no influence on the Scott bonding.

Burst was measured according to T403 om-02, the steps of which are expressly incorporated by reference into the present disclosure. Briefly, burst index refers to the maximum pressure on a unit area that paper or paperboard can withstand, normally expressed in kPa. The pressure of the tester was set to about 5 kg. After the paper is inserted into a test tank, the test button is pressed and the glass cover is automatically lowered. The maximum pressure value (kPa) is shown on a screen when the paper is torn.

The burst index is calculated as follows: X=p/g, wherein X=burst index (kPa·m²/g), p=burst (kPa), and g=basis weight of paper (g/m²).

Basis weight was measured according to T410 om-98, the steps of which are expressly incorporated by reference into the present disclosure.

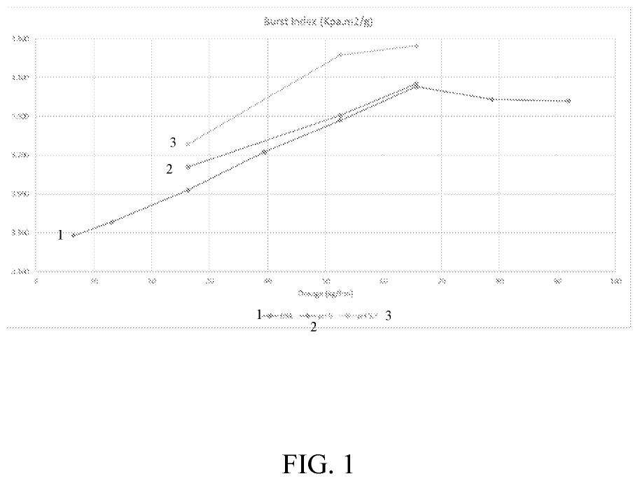

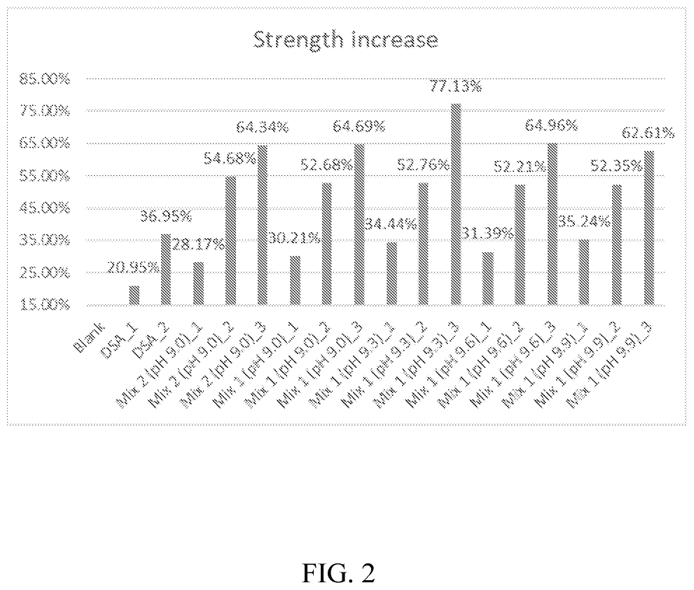

In a first set of experiments, the influence of pH was investigated. In general, the polyacrylamide glyoxalation occurs when the pH of the mixture is above about 9.0. A higher pH usually contributes to faster crosslinking. Thus, the inventors investigated the pH effect by mixing the amphoteric polymers and GPAMs at various pH values, as seen in FIGS. 1 and 2.

In FIGS. 1-4, on-site DSA, DSA, DSA 1, and DSA 2 refer to commercially available polymers of about 85-100 mol % acrylamide, about 0-5 mol % acrylic acid or itaconic acid, and about 0-10 mol % DMAEM.

The crosslinked polymer used to obtain the data in FIG. 1 was “Mixture 1,” which was formed by reacting an amphoteric GPAM (about −0.62 meq/g at pH 9.7, IV of about 4.5 dl/g) with a cationic GPAM (about 12% DADMAC-Acrylamide copolymer (backbone IV: about 0.270 dl/g)).

Mixture 1 was also used to obtain the data shown in FIG. 2, in addition to “Mixture 2,” which was formed by reacting an amphoteric GPAM (about −0.86 meq/g at pH 9.7, IV of about 1.8 dl/g) with a cationic GPAM (about 12% DADMAC-Acrylamide copolymer (backbone IV: about 0.185 dl/g)).

Interestingly, FIGS. 1 and 2 show an optimal operation window between about 9.3 to about 9.7, which showed higher strength than the tests at pH 9.0 and 9.9.

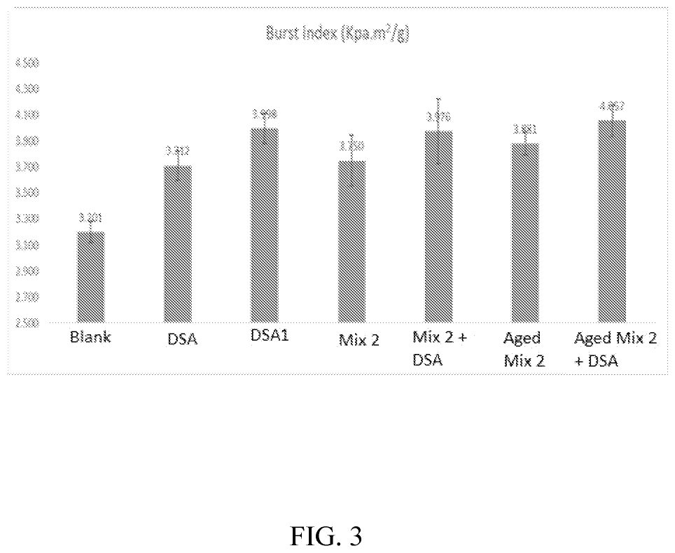

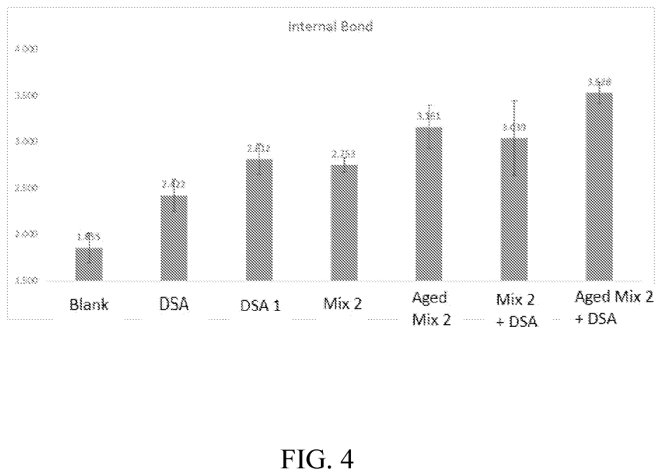

In a second set of experiments, the influence of total mixing time was investigated. The inventors discovered that extending the mixing time helped increase the amount of crosslinks. The aging effect was studied for Mixture 1 and Mixture 2 at a pH of about 9.6. The data is depicted in FIGS. 3 and 4.

In a further set of experiments, the effect of the amphoteric polymer/GPAM charge ratio was studied at a pH of about 9.7. The inventors discovered an optimal range was obtained when the anionic/cationic ratio was controlled between about 1.1 to about 1.5. The inventors also discovered that above or below this range may result in decreased performance. The resulting data is shown in Table 4 where “BW” refers to basis weight and the units for internal bonding are kg·cm/in². PGP-24 T2

TABLE 4

| | Anionic/cationic | | | | | |
|---|---|---|---|---|---|---|
| | charge ratio@ | Application | | burst | internal | |
| Sample | pH 9.7 | pH | BW | index | bonding | dewatering |
| Blank | NA | NA | 122.74 | 3.09 | 1.38 | 450.83 |
| 26 kg/ton DSA | NA | 7.0 | 122.45 | 3.60 | 1.76 | 445.67 |
| 52 kg/ton DSA | NA | 7.0 | 124.00 | 3.90 | 2.00 | 439.45 |
| 26 kg/ton Mix 2 | 1.44 | 9.0 | 124.21 | 3.66 | 1.97 | 498.94 |
| 26 kg/ton DSA + | 1.44 | 9.0 | 126.74 | 3.97 | 2.46 | 503.7 |
| 26 kg/ton Mix 2 | | | | | | |
| 26 kg/ton Mix 1 | 1.35 | 9.6~9.7 | 126.67 | 3.71 | 1.97 | 498.03 |
| 26 kg/ton DSA + | 1.35 | 9.6~9.7 | 125.91 | 3.94 | 2.51 | 482.38 |
| 26 kg/ton Mix 1 | | | | | | |
| 26 kg/ton Mix 1 | 1.18 | 9.6~9.7 | 127.38 | 3.55 | 1.97 | 490.56 |
| 26 kg/ton DSA + | 1.18 | 9.6~9.7 | 128.97 | 3.91 | 2.45 | 477.82 |
| 26 kg/ton Mix 1 | | | | | | |
| 26 kg/ton Mix 1 | 1.18 | 9.6~9.7 | 129.42 | 3.69 | 1.87 | 479.77 |
| aged for 3 h | | | | | | |
| 26 kg/ton DSA + | 1.18 | 9.6~9.7 | 127.95 | 3.97 | 2.35 | 470.07 |
| 26 kg/ton Mix 1 | | | | | | |
| aged for 3 h | | | | | | |
| 26 kg/ton Mix 1 | 1.35 | 9.6~9.7 | 129.19 | 3.70 | 2.03 | 491.5 |
| 26 kg/ton DSA + | 1.35 | 9.6~9.7 | 129.97 | 3.89 | 2.42 | 470.55 |
| 26 kg/ton Mix 1 | | | | | | |
| 26 kg/ton Mix 1 | 1 | 9.6~9.7 | precipitation | | | |
| 26 kg/ton DSA | 1 | 9.6~9.7 | precipitation | | | |
| 26 kg/ton Mix 1 | | | | | | |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a polymer” is intended to include “at least one polymer” or “one or more polymers.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers. In some embodiments, viscosity was measured using a Brookfield Programmable LVDV-II+viscometer, manufactured by Brookfield Engineering Laboratories, Inc.

Spindle 1 was used to measure 0 to 100 cps at 60 rpm, 100 to 1,000 cps was measured by Spindle 2 at 30 rpm, and 1,000-10,000 cps was measured by Spindle 3 at 12 rpm.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

1. A method of increasing the strength of paper, comprising:
reacting a cationic dialdehyde-modified polyacrylamide polymer with an amphoteric polymer to form a mixture;
monitoring a pH of the mixture;
optionally adjusting the pH of the mixture to a value from about 7.5 to about 14;
holding the mixture at the value for a period of time to form a crosslinked polymer; and
adding the crosslinked polymer to a pulp furnish.

2. The method of claim 1, wherein the period of time is from about 0.01 minutes to about 360 minutes.

3. The method of claim 1, wherein the crosslinked polymer comprises from about 1 mol % to about 40 mol % of a cationic monomer and from about 1 mol % to about 40 mol % of an anionic monomer.

4. The method of claim 1, wherein the crosslinked polymer comprises a ratio of amphoteric polymer to cationic dialdehyde-modified polyacrylamide polymer of about 1:100 to about 100:1.

5. The method of claim 1, wherein the cationic dialdehyde-modified polyacrylamide polymer comprises a cationic to anionic charge ratio of greater than 1:1.

6. The method of claim 1, wherein the cationic dialdehyde-modified polyacrylamide polymer comprises a monomer selected from the group consisting of diallyldimethylammonium chloride, N-(3-dimethylaminopropyl)methacrylamide, N-(3-dimethylaminopropyl) acrylamide, trimethyl-2-methacroyloxyethylammonium chloride, trimethyl-2-acroyloxyethyl ammonium chloride, methylacryloxyethyldimethyl benzyl ammounium chloride, acryloxyethyldimethyl benzyl ammounium chloride, (3-acrylamidopropyl)trimethyl ammonium chloride, (3-methacrylamidopropyl)trimethylammonium chloride, (3-acrylamido-3-methylbutyl)trimethylammonium chloride, 2-vinylpyridine, 2-(dimethylamino)ethyl methacrylate, 2-(dimethylamino)ethyl acrylate, a salt of any of the foregoing monomers, and any combination thereof.

7. The method of claim 1, wherein the amphoteric polymer comprises a monomer selected from the group consisting of acrylamide, methacrylamide, diallyldimethylammonium chloride, N-(3-dimethylaminopropyl)methacrylamide, N-(3-dimethylaminopropyl) acrylamide, trimethyl-2-methacroyloxyethylammonium chloride, trimethyl-2-acroyloxyethyl ammonium chloride, methylacryloxyethyldimethyl benzyl ammounium chloride, acryloxyethyldimethyl benzyl ammounium chloride, (3-acrylamidopropyl)trimethyl ammonium chloride, (3-methacrylamidopropyl)trimethylammonium chloride, (3-acrylamido-3-methylbutyl)trimethylammonium chloride, 2-vinylpyridine, 2-(dimethylamino)ethyl methacrylate, 2-(dimethylamino)ethyl acrylate, acrylic acid, methacrylic acid, itaconic acid, maleic acid, maleic anhydride, a salt of any of the foregoing monomers, and any combination thereof.

8. The method of claim 1, wherein the amphoteric polymer comprises an anionic to cationic charge ratio of about 10:1 to about 1:10.

9. (canceled)

10. The method of claim 1, wherein the pH value is between about 9.0 and about 10.

11. The method of claim 1, wherein the crosslinked polymer comprises a weight average molecular weight from about 500,000 Da to about 10,000,000 Da.

12. The method of claim 1, wherein a dry strength agent is added to the mixture.

13. The method of claim 1, wherein an effective amount of a base is added to the mixture.

14. The method of claim 1, further comprising monitoring a turbidity of the mixture and adding the crosslinked polymer to the pulp furnish when a turbidity value reaches about 20 to about 500 NTU.

15. The method of claim 1, further comprising obtaining a first turbidity value of the mixture before the holding step, monitoring a turbidity of the mixture during the holding step, and adding the crosslinked polymer to the pulp furnish when the turbidity of the mixture increases by at least about 5% as compared to the first turbidity value.

16. The method of claim 1, wherein the cationic dialdehyde-modified polyacrylamide polymer is a cationic glyoxalated polyacrylamide polymer.

17. The method of claim 1, wherein the holding step is performed in the absence of fiber.

18. A method of increasing the strength of paper, comprising:
reacting a cationic dialdehyde-modified polyacrylamide polymer with an amphoteric polymer to form a mixture comprising a crosslinked polymer;
obtaining a first turbidity value of the mixture;
holding the mixture for a period of time;
monitoring a turbidity of the mixture during the holding step; and
adding the crosslinked polymer to a pulp furnish when the turbidity of the mixture increases by at least about 5% as compared to the first turbidity value.

19.-20. (canceled)

21. The method of claim 1, wherein the crosslinked polymer comprises from about 1 mol % to about 40 mol % of a cationic monomer and from about 1 mol % to about 40 mol % of an anionic monomer.

22.-28. (canceled)

29. The method of claim 1, wherein an effective amount of a base is added to the mixture.

30. (canceled)

31. A method of increasing the strength of paper, comprising:
reacting a cationic dialdehyde-modified polyacrylamide polymer with an amphoteric polymer to form a mixture;
monitoring a pH of the mixture;
holding the pH of the mixture to a value from about 7.5 to about 14 for a period of time to form a crosslinked polymer; and
adding the crosslinked polymer to a pulp furnish.

32. (canceled)
